(19) United States
(12) Patent Application Publication
(10) Pub. No.: US 2012/0109947 A1
(43) Pub. Date: May 3, 2012

(54) MULTI-TENANT ANALYTICS PROCESSING

(75) Inventors: Sammy Yu, San Mateo, CA (US); Lemuel S. Park, Cerritos, CA (US); Rolland Yip, Foster City, CA (US); Jim Yu, Foster City, CA (US)

(73) Assignee: BRIGHTEDGE TECHNOLOGIES, San Mateo, CA (US)

(21) Appl. No.: 12/917,951

(22) Filed: Nov. 2, 2010

(51) Int. Cl. G06F 17/30; H04L 9/32

(52) U.S. Cl. 707/725; 726/8; 707/E17.084

(57) ABSTRACT

Embodiments are directed to implementing a multi-tenant architecture in an analytics platform. In an embodiment, a computer system receives a user's login credentials at a multi-tenant system. The multi-tenant system includes multiple different tenants, each of which includes various users. The multi-tenant system includes multiple instantiated partition instances configured to store various types of analytics information for each tenant. The computer system determines which partition instance the user belongs to, so that analytics information collected for the user is stored in the determined partition instance. The computer system collects analytics information based on the user's interaction with the multi-tenant system and stores the collected analytics information in the determined partition instance. The multi-tenant system is also extended for implementation in a cloud computing system.

### BACKGROUND

Software applications allow users to perform a wide variety of functions including business applications, schoolwork, entertainment and more. Applications may be installed locally on a user's computer system or they may be provided from a server over a computer network. In some cases, software functionality is provided via a web browser or other application viewer. Such software functionality is typically referred to as software as a service (SaaS).

In some cases, a computer user is required to authenticate to a server before the server will provide the desired services. Once the user is authenticated and the server has verified that the user is authorized to access the desired services, the server begins to provide the service. While the user is logged in to the server, the server may collect data regarding the user's interactions with the provided service. For example, the server may collect data regarding how long a user spends using each different portion of functionality provided by the service. The server may record which links or buttons were clicked, how much data was used, which functions were used, and other data that shows how a given service was used. Such information is typically referred to as analytics information.

Many entities use analytics information to determine how to improve their services or other offerings (e.g. web sites). The gathering of analytics information is typically performed in-house at each respective entity, leading to inefficiencies in its collection and distribution.

### BRIEF SUMMARY

Embodiments described herein are directed to implementing a multi-tenant architecture in an analytics platform. In one embodiment, a computer system receives a user's login credentials at a multi-tenant system. The multi-tenant system includes multiple different tenants, each of which includes various users. The multi-tenant system includes multiple instantiated partition instances configured to store various types of analytics information for each tenant. The computer system determines which partition instance the user belongs to, so that analytics information collected for the user is stored in the determined partition instance. The computer system collects analytics information based on the user's interaction with the multi-tenant system and stores the collected analytics information in the determined partition instance.

In another embodiment, a computer system receives a user's login credentials at a multi-tenant system. The multi-tenant system includes multiple different tenants, each of which includes various users. The multi-tenant system includes multiple instantiated partition instances configured to store various types of analytics information for each tenant. Also, the multi-tenant system is hosted in a cloud computing system. The computer system determines which partition instance the user belongs to, so that analytics information collected for the user is stored in the determined partition instance. The partition instances are stored in a cloud data store of the cloud computing system. The computer system also collects at least a portion of analytics information based on the user's interaction with the multi-tenant system and stores the collected analytics information in the cloud data store in the determined partition instance.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

Additional features and advantages will be set forth in the description which follows, and in part will be obvious from the description, or may be learned by the practice of the teachings herein. Features and advantages of the invention may be realized and obtained by means of the instruments and combinations particularly pointed out in the appended claims. Features of the present invention will become more fully apparent from the following description and appended claims, or may be learned by the practice of the invention as set forth hereinafter.

### BRIEF DESCRIPTION OF THE DRAWINGS

To further clarify the above and other advantages and features of embodiments of the present invention, a more particular description of embodiments of the present invention will be rendered by reference to the appended drawings. It is appreciated that these drawings depict only typical embodiments of the invention and are therefore not to be considered limiting of its scope. The invention will be described and explained with additional specificity and detail through the use of the accompanying drawings in which:

FIG. 1 illustrates a computer architecture in which embodiments of the present invention may operate including implementing a multi-tenant architecture in an analytics platform.

FIG. 2 illustrates a flowchart of an example method for implementing a multi-tenant architecture in an analytics platform.

FIG. 3 illustrates a flowchart of an example method for extending a multi-tenant architecture in an analytics platform to a cloud computing system.

FIG. 4 illustrates an embodiment of an instantiated partition instance.

FIG. 5 illustrates an implementation embodiment on a cloud computing system.

### DETAILED DESCRIPTION

Embodiments described herein are directed to implementing a multi-tenant architecture in an analytics platform. In one embodiment, a computer system receives a user's login credentials at a multi-tenant system. The multi-tenant system includes multiple different tenants, each of which includes various users. The multi-tenant system includes multiple instantiated partition instances configured to store various types of analytics information for each tenant. The computer system determines which partition instance the user belongs to, so that analytics information collected for the user is stored in the determined partition instance. The computer system collects analytics information based on the user's interaction with the multi-tenant system and stores the collected analytics information in the determined partition instance.

In another embodiment, a computer system receives a user's login credentials at a multi-tenant system. The multi-tenant system includes multiple different tenants, each of which includes various users. The multi-tenant system includes multiple instantiated partition instances configured to store various types of analytics information for each tenant. Also, the multi-tenant system is hosted in a cloud computing system. The computer system determines which partition instance the user belongs to, so that analytics information collected for the user is stored in the determined partition instance. The partition instances are stored in a cloud data store of the cloud computing system. The computer system also collects at least a portion of analytics information based on the user's interaction with the multi-tenant system and stores the collected analytics information in the cloud data store in the determined partition instance.

The following discussion now refers to a number of methods and method acts that may be performed. It should be noted, that although the method acts may be discussed in a certain order or illustrated in a flow chart as occurring in a particular order, no particular ordering is necessarily required unless specifically stated, or required because an act is dependent on another act being completed prior to the act being performed.

Embodiments of the present invention may comprise or utilize a special purpose or general-purpose computer including computer hardware, such as, for example, one or more processors and system memory, as discussed in greater detail below. Embodiments within the scope of the present invention also include physical and other computer-readable media for carrying or storing computer-executable instructions and/or data structures. Such computer-readable media can be any available media that can be accessed by a general purpose or special purpose computer system. Computer-readable media that store computer-executable instructions are computer storage media. Computer-readable media that carry computer-executable instructions are transmission media. Thus, by way of example, and not limitation, embodiments of the invention can comprise at least two distinctly different kinds of computer-readable media: computer storage media and transmission media.

Computer storage media includes RAM, ROM, EEPROM, CD-ROM or other optical disk storage, magnetic disk storage or other magnetic storage devices, or any other medium which can be used to store desired program code means in the form of computer-executable instructions or data structures and which can be accessed by a general purpose or special purpose computer.

A “network” is defined as one or more data links that enable the transport of electronic data between computer systems and/or modules and/or other electronic devices. When information is transferred or provided over a network or another communications connection (either hardwired, wireless, or a combination of hardwired or wireless) to a computer, the computer properly views the connection as a transmission medium. Transmissions media can include a network and/or data links which can be used to carry or desired program code means in the form of computer-executable instructions or data structures and which can be accessed by a general purpose or special purpose computer. Combinations of the above should also be included within the scope of computer-readable media.

Further, upon reaching various computer system components, program code means in the form of computer-executable instructions or data structures can be transferred automatically from transmission media to computer storage media (or vice versa). For example, computer-executable instructions or data structures received over a network or data link can be buffered in RAM within a network interface module (e.g., a “NIC”), and then eventually transferred to computer system RAM and/or to less volatile computer storage media at a computer system. Thus, it should be understood that computer storage media can be included in computer system components that also (or even primarily) utilize transmission media.

Computer-executable instructions comprise, for example, instructions and data which cause a general purpose computer, special purpose computer, or special purpose processing device to perform a certain function or group of functions. The computer executable instructions may be, for example, binaries, intermediate format instructions such as assembly language, or even source code. Although the subject matter has been described in language specific to structural features and/or methodological acts, it is to be understood that the subject matter defined in the appended claims is not necessarily limited to the described features or acts described above. Rather, the described features and acts are disclosed as example forms of implementing the claims.

Those skilled in the art will appreciate that the invention may be practiced in network computing environments with many types of computer system configurations, including, personal computers, desktop computers, laptop computers, message processors, hand-held devices, multi-processor systems, microprocessor-based or programmable consumer electronics, network PCs, minicomputers, mainframe computers, mobile telephones, PDAs, pagers, routers, switches, and the like. The invention may also be practiced in distributed system environments where local and remote computer systems, which are linked (either by hardwired data links, wireless data links, or by a combination of hardwired and wireless data links) through a network, both perform tasks. In a distributed system environment, program modules may be located in both local and remote memory storage devices.

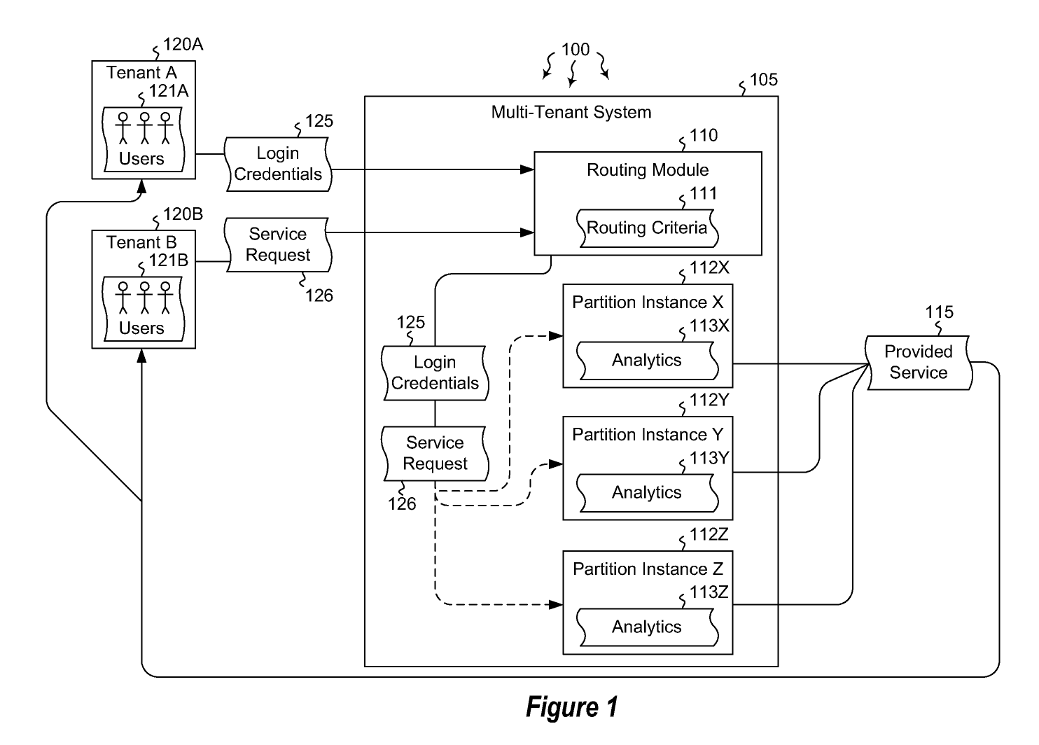

FIG. 1 illustrates a computer architecture 100 in which the principles of the present invention may be employed. Computer architecture 100 includes multi-tenant system 105. The term multi-tenant, as used herein, refers to a computing system that is configured to work with a plurality of different entities or tenants. These tenants may include organizations, corporations, government entities, schools or any other group of users. Tenants may include one user or many hundreds, thousands, millions or more users. These users may be based all over the world, and may access the multi-tenant system from different computer systems. Accordingly, multi-tenant system 105 may recognize users as being members of a tenant through a variety of means.

For instance, the multi-tenant system may recognize a user (e.g. 121A) as being a member of tenant A (120A) because the user's computer system is recognized by the multi-tenant system (e.g. by internet protocol (IP) address, media access control (MAC) address or some other computer system identifier). Additionally or alternatively, the multi-tenant system may recognize the user (e.g. 121B) as being a member of a tenant (e.g. 120B) upon identifying the user (e.g. by username, user ID, authentication credentials 125, or other identifier). Accordingly, multi-tenant system 105 may identify a given user as being a member of a given tenant by identifying the user and/or identifying the user's computer system.

In some case, multi-tenant system 105 may be configured to provide various services. The services may include software applications, software services such as web services or other data processing or software functionality. The multi-tenant system may receive service requests 126 from different users for one or more services it provides. The service request may come with or without login credentials 125 which may be sent separately. The login credentials may include a user's user name or other identifier, a password or passphrase, as well as potentially other identifying information such as biometric information. Routing module 110 of multi-tenant system 105 may be configured to receive the login credentials and service request and route those items to an appropriate partition instance (e.g. 112X, 112Y or 112Z), based on various routing criteria 111.

Partition instances may be instantiated by the multi-tenant system to provide services, data processing, communications and analytics collection for a given tenant. For instance, if a tenant were a large corporation with many thousands of users, partition instance X (112X), for example, may be instantiated to provide requested services for that corporations' users. While those users are using the provided services, the partition instance may be configured to collect analytics 113X for those users. The analytics may include any type of information relating to how the user interacts with a given service. For instance, if a service provided by partition instance 112X (e.g. provided service 115) is a web service, some of the analytics that may be recorded include, but are not limited to, the following: number of visitors, number of page views, average time spent on each web page, number of conversion events, number of success events, number of clicks on a given link or button, search engine optimization analytics such as keyword and entry data, keyword ranking and other such types of information.

The analytics information collected is stored in a data store for each partition instance. Thus, each tenant has their own data store with their own stored analytics information (e.g. partition instances Y (112Y) and Z (112Z), each with their respective stored analytics information 113Y/113Z. It will be understood that while two tenants are shown in FIG. 1, each tenant with three users, and while three partition instances are shown, substantially any number of tenants may be supported by multi-tenant system 105. Moreover, each tenant may have substantially any number of users, and multi-tenant system 105 may instantiate substantially any number of partition instances. In some cases, partition instances may be created for subgroups within a given tenant, or for particular users of a tenant. In this manner, multi-tenant system features such as scalability, high availability and flexibility may be applied to an analytics platform. Moreover, each tenant's data may be stored securely, in a partition that is separate from other tenant's information.

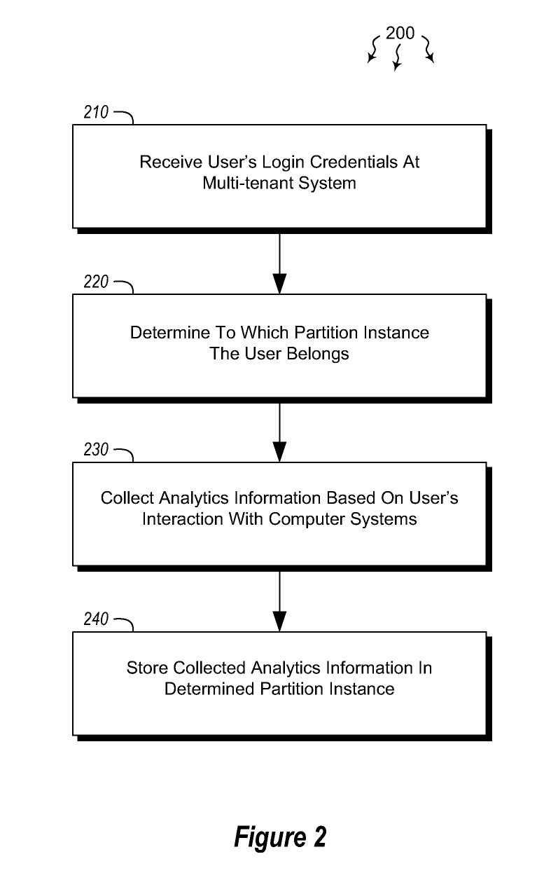

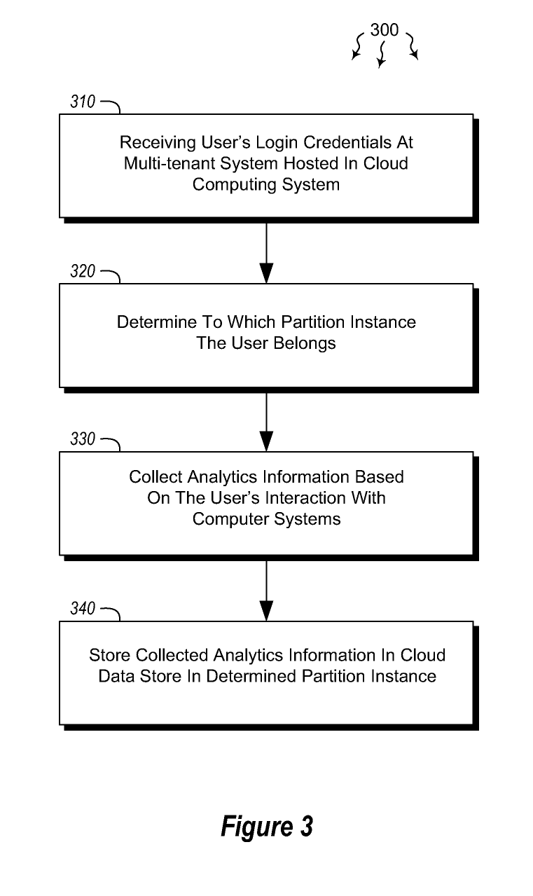

In view of the systems and architectures described above, methodologies that may be implemented in accordance with the disclosed subject matter will be better appreciated with reference to the flow charts of FIGS. 2 and 3. For purposes of simplicity of explanation, the methodologies are shown and described as a series of blocks. However, it should be understood and appreciated that the claimed subject matter is not limited by the order of the blocks, as some blocks may occur in different orders and/or concurrently with other blocks from what is depicted and described herein. Moreover, not all illustrated blocks may be required to implement the methodologies described hereinafter.

FIG. 2 illustrates a flowchart of a method 200 for implementing a multi-tenant architecture in an analytics platform. The method 200 will now be described with frequent reference to the components and data of environments 100, 400 and 500 of FIGS. 1, 4 and 5, respectively.

Method 200 includes an act of receiving a user's login credentials at a multi-tenant system, the multi-tenant system comprising a plurality of tenants, each of which includes one or more users, the multi-tenant system comprising a plurality of instantiated partition instances configured to store various types of analytics information for each tenant (act 210). For example, routing module 110 of multi-tenant system may receive login credentials 125 from user 121A of tenant 120A. As explained above, each tenant may have a plurality of different users spread over a wide geographic area. The multi-tenant system 105 may instantiate a separate partition instance for each tenant and provide any requested services (e.g. service 115) using that partition instance.

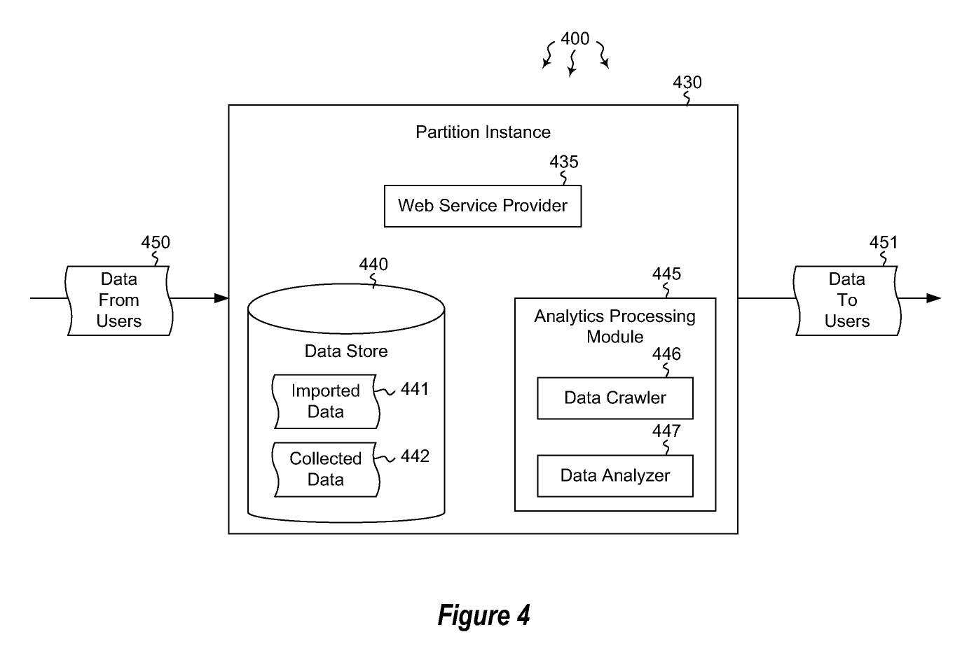

As shown in FIG. 4, a partition instance 430 may include a service provider (e.g. web service provider 435) that receives data from a user 250 (e.g. service request 126 and/or login credentials 125) and provides the requested service or provides functionality based on the user's credentials. The partition instance may collect analytics information regarding the user's interaction with the provided service. For example, analytics processing module 445 may instantiate a data crawler 446 to monitor each aspect of the user's interaction with the multi-tenant system. The collected data 442 may be stored in a partition instance-specific data store 440 (along with any imported analytics data 441 from other sources. The data analyzer 447 may be implemented to analyze the collected information, categorize it, prepare it for presentation to the user and perform any other functionality that the user may desire. The processed data 451 is then sent to the user, or is simply stored for later retrieval.

In the above examples, partition instances are instantiated for each tenant. However, in other cases, partition instances may be instantiated based on other criteria (e.g. routing criteria 111). For instance, a partition instance may be instantiated for those users or computer systems that are located in a given geographic region (e.g. in the United States). In other cases, partition instances may be instantiated for those users or computer systems that request or require a certain feature or portion of functionality. In still other cases, partition instances may be instantiated for those users or computer systems that are members of a certain organization (e.g. school, government entity, corporation, etc.), or are members of a subgroup thereof. Many other criteria are possible and those listed above should not be read as limiting the possible types of criteria that may be used. The routing module may then, upon receiving login credentials or service requests, route the requests/credentials to the proper partition instance, based on each partition's criteria.

Thus, in one embodiment, partition instances may be configured to provide services and collect analytics information for different tenants. Each tenant may represent an organization. Each user from that organization may be serviced by a particular instantiated partition instance (e.g. 112Z). In some cases (perhaps at the request of the tenant), multi-tenant system 105 may instantiate one or more different partition instances for subgroups within the organization. For instance, partition instances may be instantiated for a finance group, for a sales group, for a legal group and for a human resources group. Other groups and other grouping variations are also possible.

In another embodiment, the partition instances are instantiated based on geographic location. Thus, users (or computer systems) located in different geographic areas are serviced by different instantiated partition instances. The geographic areas may be large such as states, countries or continents, or may be small such as cities, neighborhoods or streets. Geographic area may also refer to different locations in a building. For instance, each floor of a building may be serviced by a different partition instance. Multi-tenant system administrators may be able to define and change the criteria that define which computers or users are in a given geographic area.

In another embodiment, the partition instances are instantiated based on an indicated feature provided by the multi-tenant system. In such cases, users requesting various different features are serviced by different instantiated partition instances. Thus, a user that requests, for example feature X, may be routed to partition instance X (112X). This may be used in scenarios where certain groups of workers in an organization use a particular type of software (e.g. accounting software). Those workers may then be routed to work with a partition that provides the accounting software.

As mentioned previously, the categories in the examples above are not exclusive and many other types of categories may be used in addition to or in conjunction with those listed above. Many different partition instances may be used with a given tenant, based on which routing criteria are used. Partition instances may also be partitioned by time interval. For instance, a given partition instance may be configured to service a given tenant for a certain period of time (a day, week, month, year, etc.). Moreover, in some cases, instantiated partition instances may be partitioned by both time interval and one of the following: by organization, by feature or by geographic area. In these cases, the instantiated partition would process and store data for those users or computer systems within its domain for the specified time frame in the time interval.

Method 200 includes an act of the multi-tenant system determining which partition instance the user belongs to, such that analytics information collected for the user is stored in the determined partition instance (act 220). For example, routing module 110 of multi-tenant system 105 determines which partition instance the user belongs to and routes that user's communications to the appropriate partition instance. Any analytics information collected regarding that user's interaction with the partition instance are stored in the partition instance data store 440.

Method 200 also includes an act of collecting at least a portion of analytics information based on the user's interaction with the multi-tenant system (act 230). The analytics information may include any type of usage information, usage history, time data or other information that may be used to show how the user used and interacted with a given service or program. This analytics information may be processed by analytics processing module 445 and may be prepared for storage and/or transmission to a user or other software program. In some cases, the analytics information is configured for quick retrieval through a web application or syndication service.

Method 200 includes an act of storing the collected analytics information in the determined partition instance (act 240). For example, data store 440 may store the collected analytics information 442. This information may be stored in addition to other analytics information for the tenant. In some cases, the multi-tenant system may receive analytics data from another analytics system (e.g. imported data 441). This imported data may be used as input data for determining analytics information for a given tenant. This imported data may include analytics data from other services the user has used or from past uses with another system.

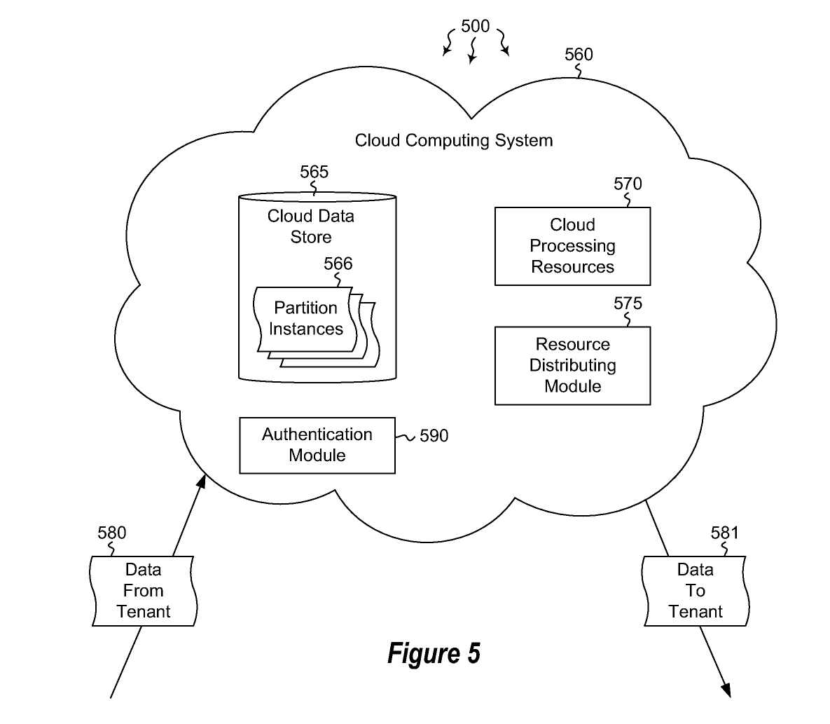

FIG. 3 illustrates a flowchart of a method 300 for establishing a multi-tenant architecture in an analytics platform and extending that architecture to the cloud. As used herein, and as is understood in the art, the cloud refers to a distributed system that is accessible over the internet and can provide many types of services including storage, application access and others. The method 300 will now be described with frequent reference to the components and data of environments 100 of FIGS. 1 and 500 of FIG. 5.

Method 300 includes an act of receiving a user's login credentials at a multi-tenant system, the multi-tenant system comprising a plurality of tenants, each of which includes one or more users, the multi-tenant system comprising a plurality of instantiated partition instances configured to store various types of analytics information for each tenant, wherein the multi-tenant system is hosted in a cloud computing system (act 310). For example, authentication module 590 of cloud computing system 560 may receive login credentials (e.g. in data 580) which are used to identify the user (e.g. 121B) as being a member of a given tenant (e.g. tenant 120B). The multi-tenant system 105 may be hosted in a cloud computing system. As such, the multi-tenant system may be hosted on a plurality of computer systems distributed over a wide geographic area. Moreover, each of the instantiated instances may be run on different computer systems of the cloud or may be spread over a plurality of different computer systems.

In some case, the processing resources of the cloud computing system may be apportioned to each tenant based on the tenant's current or anticipated use. Thus, if a user is a heavy user needing a large amount of processing and/or transmission resources, more of the cloud's processing resources (e.g. 570) can be apportioned to the user (e.g. by resource distributing module 575). The reverse is also true. Similarly, if a user indicates that their intended use will be higher than its current use, the cloud can plan to apportion a greater amount of processing resources to that user at a future time. Once the user has completed their planned task (or their needs otherwise drop), the processing resources apportioned to a given tenant or user may be reapportioned to the cloud.

Method 300 includes an act of the multi-tenant system determining which partition instance the user belongs to, such that analytics information collected for the user is stored in the determined partition instance, the partition instances being stored in a cloud data store of the cloud computing system (act 320). As shown in FIG. 5, for example, partition instances 566 are stored in cloud data store 565. The cloud data store may be distributed over a plurality of computer systems and, as such, may enjoy high reliability, high availability and a high degree of security (as users are typically required to be authenticated to access the cloud data store).

In some case, the analytics information collected by the partition instances 566 includes search engine optimization analytics. These search engine optimization analytics may be ranked and organized by geographic area, by feature, by organization and/or by time interval. In some cases, the analytics may be ranked by geographic area, feature or organization within a defined time interval.

Returning to FIG. 3, method 300 includes an act of collecting at least a portion of analytics information based on the user's interaction with the multi-tenant system (act 330). For example, data crawler 446 of FIG. 4 (which is part of partition instance 430) may collect analytics information based on the user's interactions with cloud computing system 560 and/or the services provided by the cloud computing system (e.g. data to tenant 581). The crawler may be specialized and optimized per partition instance, and each crawler may be configured to look for different service usage. In some case, multiple crawlers may be instantiated, where each crawler is looking for specific user behavior or program usage.

Method 300 also includes an act of storing the collected analytics information in the cloud data store in the determined partition instance (act 340). For example, the analytics information collected by the crawler may be stored in cloud data store 565, in the corresponding partition instance 566. The stored data may be arranged or formatted for simple retrieval by a web service or through other authenticated means.

In some cases, the multi-tenant system running on the cloud computing system may be configured to process particular nodes within a partition instance. Thus, if a partition instance has analytics information for multiple different users, or for multiple different time frames or for different geographic groups, etc., the multi-tenant system may be configured to access and process the data of specific users or time frames or groups (nodes). Thus, while the multi-tenant system is scalable for large numbers of tenants and users, each individual portion of stored analytics data may be retrieved and accessed by itself, separate from the data of other users or tenants.

Accordingly, systems, methods and computer program products are provided which implement a multi-tenant architecture in an analytics platform. Still further, systems, methods and computer program products are provided which establish a multi-tenant architecture in an analytics platform and extend that architecture to the cloud.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

We claim:

1. At a computer system including a processor and a memory, in a computer networking environment including a plurality of computing systems, a computer-implemented method for implementing a multi-tenant architecture in an analytics platform, the method comprising:
an act of receiving a user's login credentials at a multi-tenant system, the multi-tenant system comprising a plurality of tenants, each of which includes one or more users, the multi-tenant system comprising a plurality of instantiated partition instances configured to store various types of analytics information for each tenant;
an act of the multi-tenant system determining which partition instance the user belongs to, such that analytics information collected for the user is stored in the determined partition instance;
an act of collecting at least a portion of analytics information based on the user's interaction with the multi-tenant system; and
an act of storing the collected analytics information in the determined partition instance.

2. The method of claim 1, further comprising an act of instantiating one or more partition instances.

3. The method of claim 2, wherein the instantiated partition instance is configured to provide a requested service to the user.

4. The method of claim 2, wherein each partition instance is configured to provide services and collect analytics information for a different tenant.

5. The method of claim 4, wherein each tenant represents an organization and wherein each user from that organization is serviced by the instantiated partition instance.

6. The method of claim 5, wherein separate partition instances are instantiated for each subgroup of the organization.

7. The method of claim 2, wherein the partition instances are instantiated based on geographic location, such that users located in different geographic areas are serviced by different instantiated partition instances.

8. The method of claim 2, wherein the partition instances are instantiated based on an indicated feature provided by the multi-tenant system, such that users requesting different features are serviced by different instantiated partition instances.

9. The method of claim 2, wherein the instantiated partition instances are partitioned by time interval.

10. The method of claim 9, wherein the instantiated partition instances are partitioned by both time interval and at least one of the following: by organization, by feature and by geographic area.

11. The method of claim 9, wherein the instantiated partition instances partitioned by time interval are configured to only process and store data within the time frame specified by the time interval.

12. The method of claim 1, wherein the multi-tenant system receives analytics data from at least one other analytics system as input data for determining analytics information for a given tenant.

13. The method of claim 1, wherein the multi-tenant system is configured to process one or more particular nodes within a partition instance.

14. A computer program product for implementing a method for establishing a multi-tenant architecture in an analytics platform, the computer program product comprising one or more computer-readable storage media having stored thereon computer-executable instructions that, when executed by one or more processors of the computing system, cause the computing system to perform the method, the method comprising:
an act of receiving a user's login credentials at a multi-tenant system, the multi-tenant system comprising a plurality of tenants, each of which includes one or more users, the multi-tenant system comprising a plurality of instantiated partition instances configured to store various types of analytics information for each tenant, wherein the multi-tenant system is hosted in a cloud computing system;
an act of the multi-tenant system determining which partition instance the user belongs to, such that analytics information collected for the user is stored in the determined partition instance, the partition instances being stored in a cloud data store of the cloud computing system;
an act of collecting at least a portion of analytics information based on the user's interaction with the multi-tenant system; and
an act of storing the collected analytics information in the cloud data store in the determined partition instance.

15. The computer program product of claim 14, wherein processing resources of the cloud computing system are apportioned to each tenant based on at least one of the tenant's current and anticipated use.

16. The computer program product of claim 15, wherein the processing resources apportioned to a given tenant are reapportioned to the cloud once processing for the tenant is completed.

17. The computer program product of claim 15, wherein the search engine optimization analytics are ranked and organized by at least one of the following: by geographic area, by feature, by organization and by time interval.

18. The computer program product of claim 14, wherein the analytics information includes at least a portion of search engine optimization analytics.

19. The computer program product of claim 14, wherein the analytics information is organized for retrieval by a web application.

20. A computer system comprising the following:
one or more processors;
system memory;
one or more computer-readable storage media having stored thereon computer-executable instructions that, when executed by the one or more processors, causes the computing system to perform a method for implementing a multi-tenant architecture in an analytics platform, the method comprising the following:
an act of an act of receiving a user's login credentials at a multi-tenant system, the multi-tenant system comprising a plurality of tenants, each of which includes one or more users, the multi-tenant system comprising a plurality of instantiated partition instances configured to store various types of analytics information for each tenant;
an act of the multi-tenant system determining which partition instance the user belongs to, such that analytics information collected for the user is stored in the determined partition instance;
an act of collecting at least a portion of analytics information based on the user's interaction with the multi-tenant system; and
an act of storing the collected analytics information in the determined partition instance.
